(19) United States
(12) Patent Application Publication
(10) Pub. No.: US 2026/0244374 A1
(43) Pub. Date: Aug. 20, 2026

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventor: Mitsuhiro FUKUSHIMA, Kanagawa (JP)

(73) Assignee: FUJIFILM Business Innovation Corp., Tokyo (JP)

(21) Appl. No.: 19/298,428

(22) Filed: Aug. 13, 2025

(30) Foreign Application Priority Data
Feb. 19, 2025 (JP) 2025-025402

(51) Int. Cl. G06F 3/12

(52) U.S. Cl. CPC G06F 3/1215; G06F 3/1245

(57) ABSTRACT

An information processing system includes a processor configured to: in a case of executing printing processing in which printing is performed while switching a paper type of paper, on which a document including a plurality of pages is to be printed, to a paper type set for each page, when an instruction is received from a user to shorten a printing time as compared to a case where printing is performed in accordance with set paper types, convert a processing content of the printing processing to reduce the number of times paper is switched; and execute the printing processing with the converted processing content.

### CROSS-REFERENCE TO RELATED APPLICATIONS

This application is based on and claims priority under 35 USC 119 from Japanese Patent Application No. 2025-025402 filed February 19, 2025.

### BACKGROUND

### Technical Field

The present disclosure relates to an information processing system and a non-transitory computer readable medium.

### Related Art

Japanese Unexamined Patent Application Publication No. 2010-190914 discloses an image forming apparatus that controls fixing in accordance with the characteristics of paper in consideration of the producibility of printing processing and the accuracy of fixing control.

Japanese Unexamined Patent Application Publication No. 2006-082262 discloses an image processing apparatus that prevents the deterioration in image quality due to processing of a large number of print jobs having similar attributes and that smooths the usage statuses of units that process the print jobs to improve the durability of the units.

### SUMMARY

There is a disclosed image forming apparatus that includes a plurality of paper trays in which paper of different paper types can be set and that is capable of executing printing processing in which printing is performed while switching the paper type of paper, on which a document including a plurality of pages is to be printed, to the paper type set for each page.

However, when the printing processing is executed while switching a plurality of paper types, there is a problem of a longer printing time as compared to a case where the paper types are not switched.

Aspects of non-limiting embodiments of the present disclosure relate to providing an information processing system and a program that, when executing printing processing in which a plurality of pages is printed on paper of a plurality of paper types, can shorten the printing time as compared to a case where printing is performed in accordance with the set paper types.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a processor configured to: in a case of executing printing processing in which printing is performed while switching a paper type of paper, on which a document including a plurality of pages is to be printed, to a paper type set for each page, when an instruction is received from a user to shorten a printing time as compared to a case where printing is performed in accordance with set paper types, convert a processing content of the printing processing to reduce the number of times paper is switched; and execute the printing processing with the converted processing content.

### BRIEF DESCRIPTION OF THE DRAWINGS

Exemplary embodiments of the present disclosure will be described in detail based on the following figures, wherein:

FIG. 1 is a diagram illustrating a system configuration of an image forming system according to an exemplary embodiment;

FIG. 2 is a block diagram illustrating a hardware configuration of an image forming apparatus;

FIG. 3 is a diagram illustrating processing during print job execution;

FIG. 4 is a graph illustrating changes in productivity during print job execution;

FIG. 5 is a diagram illustrating processing during print job execution;

FIG. 6 is a graph illustrating changes in productivity during print job execution;

FIG. 7 is a diagram illustrating processing during print job execution;

FIG. 8 is a graph illustrating changes in productivity during print job execution; and

FIG. 9 is a flowchart illustrating the flow of processing during print job execution.

### DETAILED DESCRIPTION

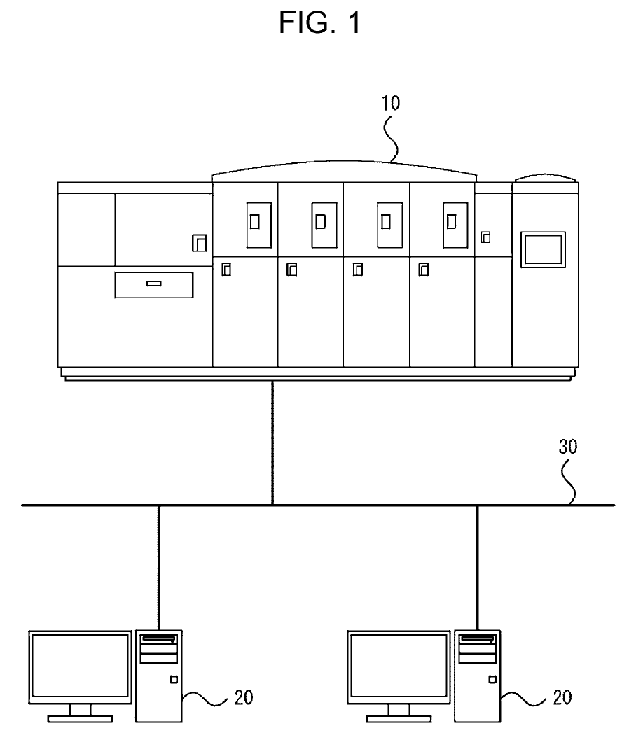

Exemplary embodiments for implementing the technology of the present disclosure will be described below in detail with reference to the drawings. FIG. 1 is a diagram illustrating a system configuration of an image forming system according to an exemplary embodiment.

As illustrated in FIG. 1, the image forming system according to the present exemplary embodiment includes an image forming apparatus 10 and a terminal device 20. The image forming apparatus 10 is an example of an information processing system according to the technology of the present disclosure.

The image forming apparatus 10 includes a plurality of paper trays in which paper of different paper types can be set. The image forming apparatus 10 is capable of executing printing processing (hereinafter referred to as "print job") in which printing is performed while switching the paper type of paper, on which a document including a plurality of pages is to be printed, to the paper type set for each page.

The terminal device 20 is connected to the image forming apparatus 10 via a network 30. The terminal device 20 is a terminal that operates the image forming apparatus 10. The terminal device 20 generates print data and transmits the print data to the image forming apparatus 10. The terminal device 20 is implemented by, for example, a computer or a smartphone.

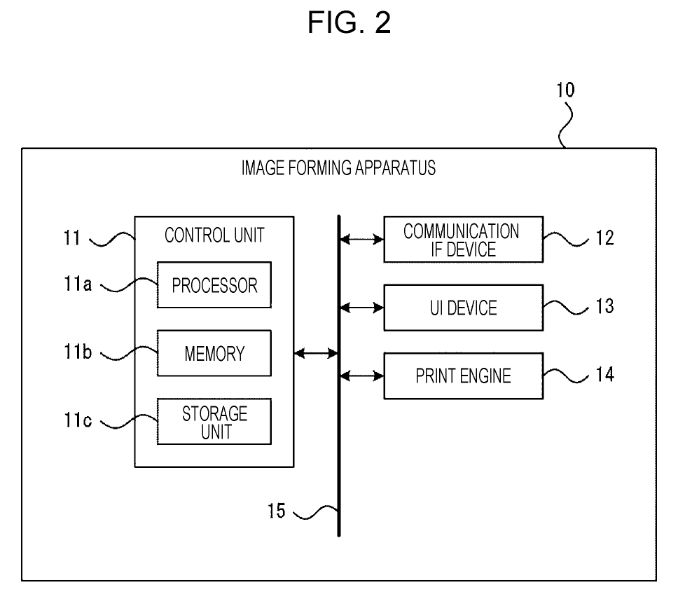

Next, a hardware configuration of the image forming apparatus 10 according to the present exemplary embodiment will be described. FIG. 2 is a block diagram illustrating a hardware configuration of the image forming apparatus 10.

As illustrated in FIG. 2, the image forming apparatus 10 includes a control unit 11, a communication interface (abbreviated as "communication IF") device 12, a user interface device (abbreviated as "UI device") 13, and a print engine 14. These components are connected to one another via a control bus 15.

The control unit 11 includes a processor 11a, a memory 11b, and a storage unit 11c. The processor 11a executes predetermined processing based on a program that is read from the storage unit 11c and loaded into the memory 11b. The storage unit 11c includes, for example, a ROM, an HDD, or an SSD. The storage unit 11c stores various programs, data, etc.

In the description according to the present exemplary embodiment, the processor 11a reads and executes a program stored in the storage unit 11c, but this is not a limitation. The program may be provided in a form of being recorded in a computer-readable recording medium as described above. Further, the program may be acquired from an external device via a communication line.

The communication IF device 12 transmits and receives data to and from an external device or the like. The UI device 13 is, for example, a device for a user to receive or input information, such as a touch panel and/or a button. The print engine 14 prints an image on a recording medium such as print paper.

The image forming apparatus 10 according to the present exemplary embodiment is capable of executing a print job in which printing is performed while switching the paper type of paper, on which a document including a plurality of pages is to be printed, to the paper type set for each page. However, when the print job is executed while switching a plurality of paper types, there is a problem of a longer printing time as compared to a case where the paper types are not switched.

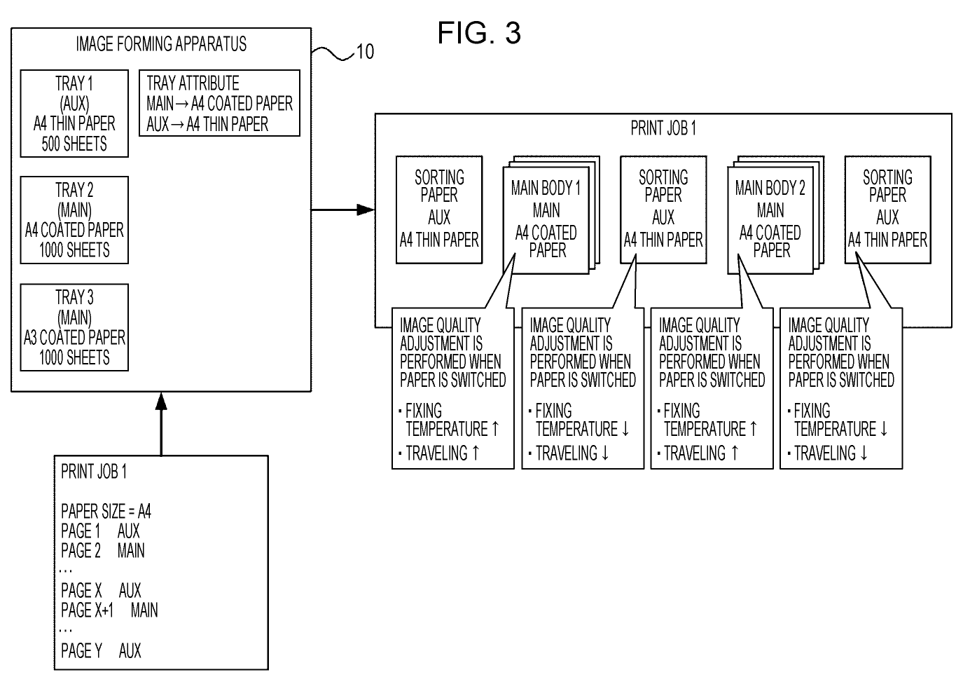

Specifically, as illustrated in FIG. 3, it is assumed that the image forming apparatus 10 includes three trays, i.e., tray 1, tray 2, and tray 3. Further, the attribute indicating the paper type can be assigned to each tray. Attributes are assigned, for example, "MAIN" indicating the main paper used, "SUB" indicating the subsidiary paper used, and "AUX" indicating the auxiliary paper used.

In this example, 500 sheets of A4 thin paper can be set in the tray 1, and the attribute "AUX" is assigned to the tray 1. 1000 sheets of A4 coated paper can be set in the tray 2, and the attribute "MAIN" is assigned to the tray 2. 1000 sheets of A3 coated paper can be set in the tray 3, and the attribute "MAIN" is assigned to the tray 3.

In the case described here, a job is executed as a print job 1, in which one sheet of A4 thin paper is printed as sorting paper, a plurality of sheets of A4 coated paper is printed as a main body 1, one sheet of A4 thin paper is printed as sorting paper, a plurality of sheets of A4 coated paper is printed as a main body 2, and finally one sheet of A4 thin paper is printed as sorting paper.

The optimal fixing temperature and the optimal traveling speed during printing differ between A4 thin paper and A4 coated paper. Specifically, the optimal fixing temperature and traveling speed of A4 thin paper are lower than those of A4 coated paper.

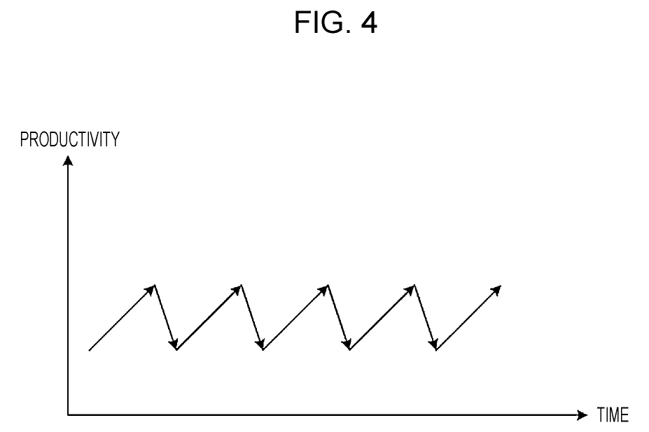

For this reason, every time paper is switched, image quality adjustment is performed to adjust the fixing temperature and the traveling speed. As a result, as illustrated in FIG. 4, the productivity during printing varies. Here, the productivity refers to the number of prints per unit time.

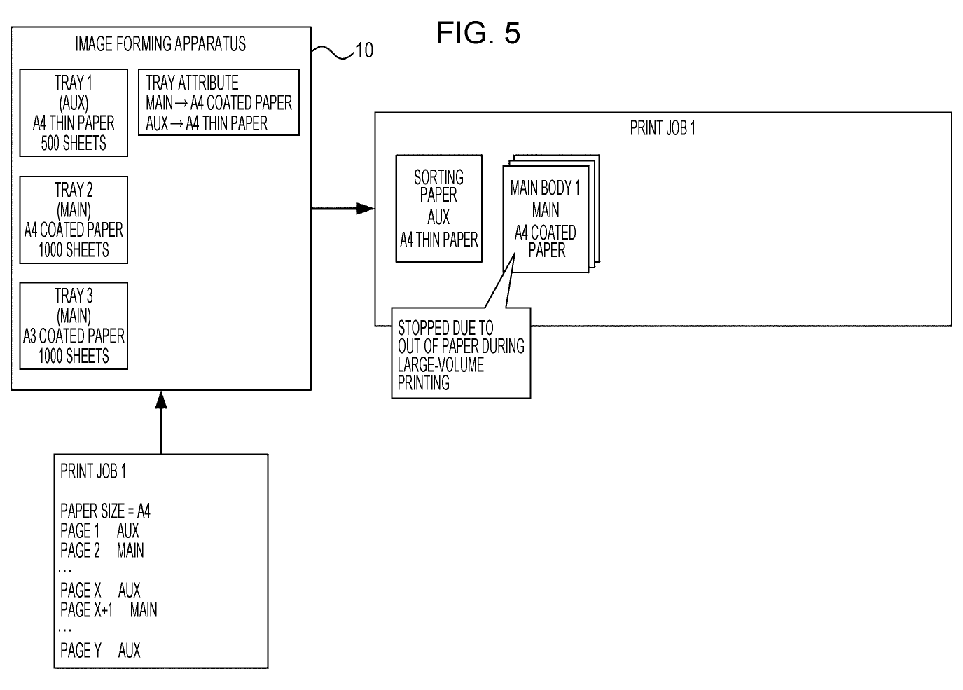

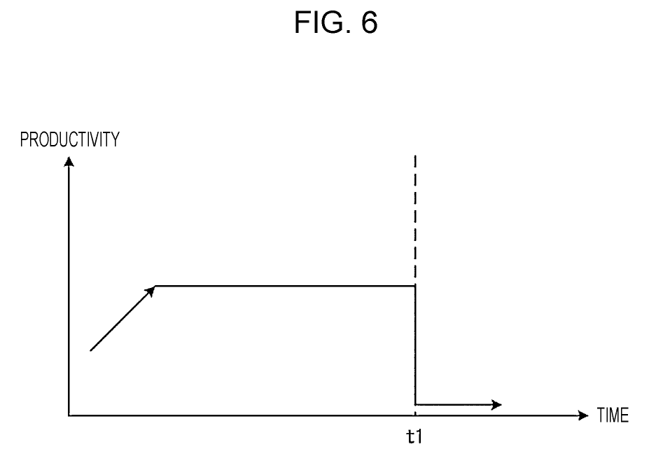

As illustrated in FIG. 5, for example, when large-volume printing is performed for the main body 1 and the paper runs out in the tray 2, the printing is stopped at a time t1 when the paper runs out, which causes no productivity, as illustrated in FIG. 6.

Thus, when a print job is executed to print a plurality of pages on the paper with a plurality of paper types, there is a need to shorten the printing time as compared to a case where printing is performed in accordance with the set paper types.

To meet such a need, in a case of executing a print job in which printing is performed while switching the paper type of paper, on which a document including a plurality of pages is to be printed, to the paper type set for each page, when an instruction is received from a user to shorten the printing time as compared to a case where printing is performed in accordance with the set paper types, the control unit 11 of the image forming apparatus 10 according to the present exemplary embodiment converts the processing content of the print job to reduce the number of times paper is switched and executes the print job with the converted processing content.

Here, the control unit 11 may convert the processing content of the print job to unify the paper types of paper used in the print job into one paper type. In this case, the control unit 11 may convert the processing content of the print job to unify the paper types of paper used in the print job into the paper type with the largest number of prints among the paper types. Further, the control unit 11 may convert the processing content of the print job to unify the paper types of paper used in the print job into the paper type with the highest printing speed among the paper types.

When there are three or more paper types of paper used in the print job, the control unit 11 may convert the processing content of the print job to unify a part of the paper types into a paper type with the highest printing speed among the part of the paper types. In this case, when a difference in the printing speed between two certain paper types falls within a set first threshold, the control unit 11 may not change the two paper types. When the paper types are arranged in descending order of printing speed and, in all the combinations of adjacent paper types in the order, a difference in the printing speed between two paper types falls within the set threshold, at least the combination of paper types with the highest printing speed may not be changed.

When the number of times the paper type is switched in the print job exceeds a set second threshold, the control unit 11 may make a notification to confirm whether to shorten the printing time as compared to a case where printing is performed in accordance with the set paper types.

Next, a detailed description will be given of an example of processing performed when the image forming apparatus 10 according to the present exemplary embodiment executes a print job.

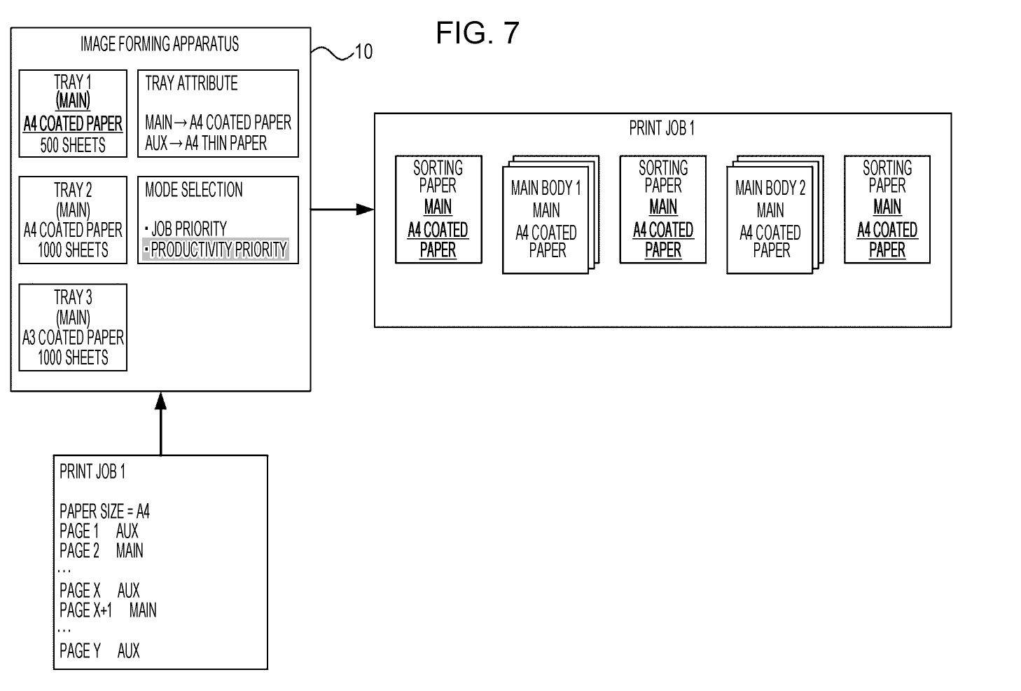

As illustrated in FIG. 7, the image forming apparatus 10 according to the present exemplary embodiment can switch between two output modes: a job priority mode in which printing is performed in accordance with the settings of a print job; and a productivity priority mode in which the number of times paper is switched is reduced to improve the productivity as compared to the job priority mode.

With regard to the switching of the output mode, an instruction may be received from the user for each print job, or in a case where the user gives an instruction for automatic mode selection, the output mode may be automatically set to the productivity priority mode when the set second threshold is exceeded, as described above.

When the productivity priority mode is selected, the control unit 11 converts the processing content of the print job 1 to unify the paper types of paper used in the print job 1 into one paper type.

Here, as an example, the control unit 11 converts the processing content of the print job 1 to unify the paper types of paper used in the print job 1 into A4 coated paper, which has the largest number of prints among the paper types.

Since A4 thin paper is no longer used due to the above conversion, the user may be notified to replace the paper in the tray 1 with A4 coated paper. Thus, the number of A4 coated paper loaded can be increased and therefore, when printing is performed on a plurality of sheets of paper using only A4 coated paper, the occurrence of paper run-out is suppressed.

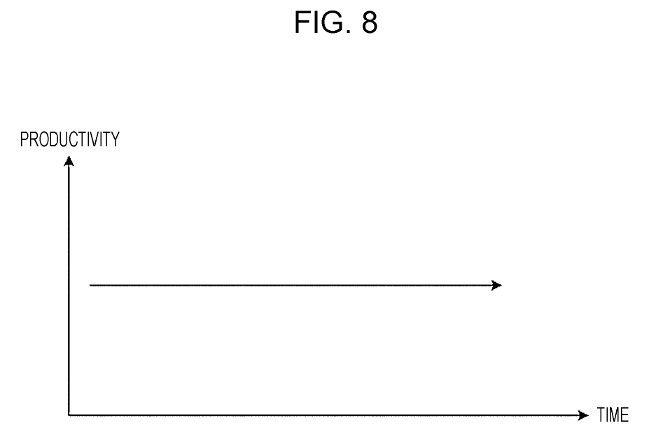

As a result of converting the processing content of the print job 1 as described above, there is no switching of paper during printing, and thus the print job 1 can be executed while consistently maintaining high productivity, as illustrated in FIG. 8.

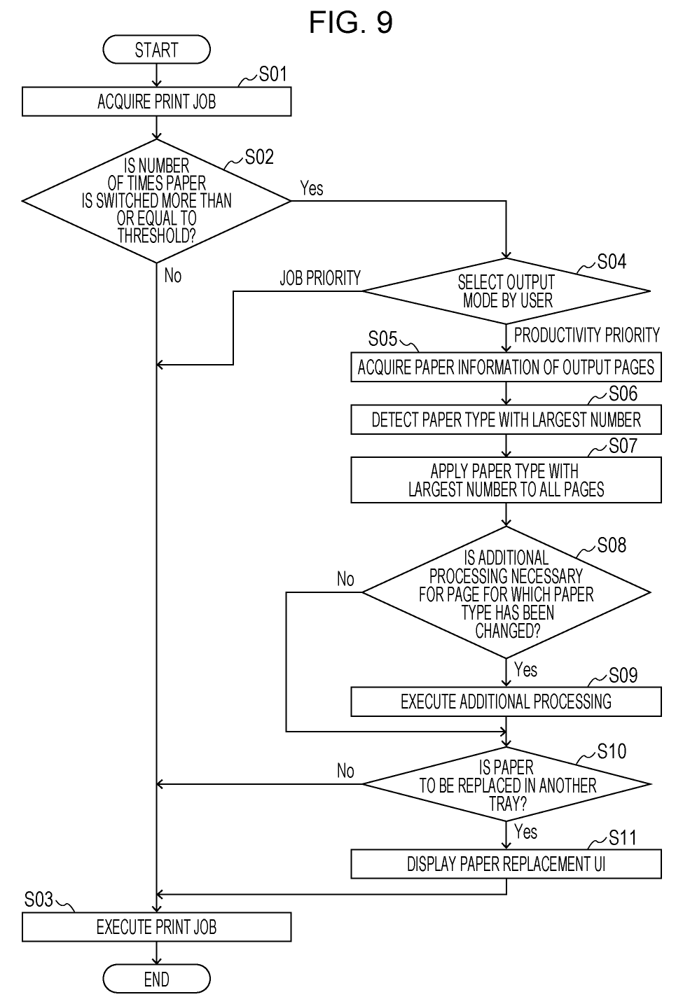

Next, with reference to the flowchart of FIG. 9, a description is given of an example of the flow of processing performed when the image forming apparatus 10 according to the present exemplary embodiment executes the print job.

First, in step S01, the control unit 11 of the image forming apparatus 10 acquires a print job.

Subsequently, in step S02, the control unit 11 determines whether the number of times paper is switched in the acquired print job is more than or equal to a threshold.

When it is determined in step S02 that the number of times paper is switched is less than the threshold (determination result: No), the control unit 11 executes the print job in step S03 and terminates the processing.

When it is determined in step S02 that the number of times paper is switched is more than or equal to the threshold (determination result: Yes), the control unit 11 causes the user to select the output mode in step S04.

When the user selects the job priority mode in step S04, the control unit 11 executes the print job in step S03 and terminates the processing.

When the user selects the productivity priority mode in step S04, the control unit 11 acquires paper information of the output pages in the print job in step S05.

Subsequently, in step S06, the control unit 11 detects the paper type with the largest number of pages among the output pages.

Subsequently, in step S07, the control unit 11 converts the processing content of the print job so that the paper type with the largest number is applied to all pages.

Subsequently, in step S08, the control unit 11 determines whether additional processing, such as adding a watermark or a frame, is necessary for the page for which the paper type has been changed.

When it is determined in step S08 that additional processing is necessary (determination result: Yes), the control unit 11 performs the additional processing in step S09 and proceeds to step S10. When it is determined in step S08 that additional processing is unnecessary (determination result: No), the control unit 11 proceeds to step S10.

Subsequently, in step S10, the control unit 11 determines whether to replace the paper in another tray other than the tray of the paper type with the largest number of pages among the output pages.

When it is determined in step S10 that the paper is not to be replaced in another tray (determination result: No), in step S03, the control unit 11 executes the print job and terminates the processing.

When it is determined in step S10 that the paper is to be replaced in another tray (determination result: Yes), in step S11, the control unit 11 displays a user interface prompting the user to replace the paper and causes the user to replace the paper. In step S03, the control unit 11 executes the print job and terminates the processing.

### Modification

While the image forming system according to the exemplary embodiment of the present disclosure has been described above, the technology of the present disclosure is not limited to the above-described exemplary embodiment and may be modified as appropriate.

According to the above exemplary embodiment, the processor refers to a processor in a broad sense and includes a general-purpose processor (e.g., central processing unit (CPU)) and dedicated processor (e.g., graphics processing unit (GPU), application specific integrated circuit (ASIC), field programmable gate array (FPGA), and programmable logic device).

In addition, the operation of the processor according to the exemplary embodiment described above may be performed not only by one processor but also by a plurality of processors existing at physically separated positions in cooperation with each other. In addition, the order of each operation of the processor is not limited to the order described in each of the exemplary embodiments, and may be changed as appropriate.

In addition, in the technology according to the present disclosure, the system includes both a system configured by a plurality of devices and a system configured by a single device.

The technique of the present disclosure can also be applied to a program and a program product.

### Appendix

(((1)))

An information processing system comprising a processor configured to:

in a case of executing printing processing in which printing is performed while switching a paper type of paper, on which a document including a plurality of pages is to be printed, to a paper type set for each page, when an instruction is received from a user to shorten a printing time as compared to a case where printing is performed in accordance with set paper types, convert a processing content of the printing processing to reduce the number of times paper is switched; and

execute the printing processing with the converted processing content.

(((2)))

The information processing system according to (((1))), wherein the processor is configured to convert the processing content of the printing processing to unify paper types of paper used in the printing processing into one paper type.

(((3)))

The information processing system according to (((2))), wherein the processor is configured to convert the processing content of the printing processing to unify the paper types of paper used in the printing processing into a paper type with the largest number of prints among the paper types.

(((4)))

The information processing system according to (((2))), wherein the processor is configured to convert the processing content of the printing processing to unify the paper types of paper used in the printing processing into a paper type with the highest printing speed among the paper types.

(((5)))

The information processing system according to (((1))), wherein when there are three or more paper types of paper used in the printing processing, the processor is configured to convert the processing content of the printing processing to unify a part of the paper types into a paper type with the highest printing speed among the part of the paper types.

(((6)))

The information processing system according to (((5))), wherein when a difference in a printing speed between two certain paper types falls within a set first threshold, the processor is configured not to change the two paper types.

(((7)))

The information processing system according to any one of (((1))) to (((6))), wherein when the number of times the paper type is switched in the printing processing exceeds a set second threshold, the processor is configured to make a notification to confirm whether to shorten a printing time as compared to a case where printing is performed in accordance with the set paper types.

(((8)))

A program causing a computer to execute a process comprising:

in a case of executing printing processing in which printing is performed while switching a paper type of paper, on which a document including a plurality of pages is to be printed, to a paper type set for each page, when an instruction is received from a user to shorten a printing time as compared to a case where printing is performed in accordance with set paper types, converting a processing content of the printing processing to reduce the number of times paper is switched, and

executing the printing processing with the converted processing content.

What is claimed is:

1. An information processing system comprising:
a processor configured to:
in a case of executing printing processing in which printing is performed while switching a paper type of paper, on which a document including a plurality of pages is to be printed, to a paper type set for each page, when an instruction is received from a user to shorten a printing time as compared to a case where printing is performed in accordance with set paper types, convert a processing content of the printing processing to reduce a number of times paper is switched; and
execute the printing processing with the converted processing content.

2. The information processing system according to claim 1, wherein the processor is configured to convert the processing content of the printing processing to unify paper types of paper used in the printing processing into one paper type.

3. The information processing system according to claim 2, wherein the processor is configured to convert the processing content of the printing processing to unify the paper types of paper used in the printing processing into a paper type with the largest number of prints among the paper types.

4. The information processing system according to claim 2, wherein the processor is configured to convert the processing content of the printing processing to unify the paper types of paper used in the printing processing into a paper type with the highest printing speed among the paper types.

5. The information processing system according to claim 1, wherein when there are three or more paper types of paper used in the printing processing, the processor is configured to convert the processing content of the printing processing to unify a part of the paper types into a paper type with the highest printing speed among the part of the paper types.

6. The information processing system according to claim 5, wherein when a difference in a printing speed between two certain paper types falls within a set first threshold, the processor is configured not to change the two paper types.

7. The information processing system according to claim 1, wherein when the number of times the paper type is switched in the printing processing exceeds a set second threshold, the processor is configured to make a notification to confirm whether to shorten a printing time as compared to a case where printing is performed in accordance with the set paper types.

8. A non-transitory computer readable medium storing a program causing a computer to execute a process comprising:
in a case of executing printing processing in which printing is performed while switching a paper type of paper, on which a document including a plurality of pages is to be printed, to a paper type set for each page, when an instruction is received from a user to shorten a printing time as compared to a case where printing is performed in accordance with set paper types, converting a processing content of the printing processing to reduce the number of times paper is switched; and
executing the printing processing with the converted processing content.
